(19) United States
(12) Patent Application Publication
(10) Pub. No.: US 2013/0164602 A1
(43) Pub. Date: Jun. 27, 2013

(54) ENERGY STORAGE DEVICE

(71) Applicants: Li-Duan Tsai, Hsinchu City (TW); Chung-Hsiang Chao, Pingtung County (TW); Jenn-Yeu Hwang, Keelung City (TW); Chun-Lung Li, Taoyuan County (TW)

(72) Inventors: Li-Duan Tsai, Hsinchu City (TW); Chung-Hsiang Chao, Pingtung County (TW); Jenn-Yeu Hwang, Keelung City (TW); Chun-Lung Li, Taoyuan County (TW)

(73) Assignee: INDUSTRIAL TECHNOLOGY RESEARCH INSTITUTE, Hsinchu (TW)

(21) Appl. No.: 13/561,097

(22) Filed: Jul. 30, 2012

(30) Foreign Application Priority Data
Dec. 27, 2011 (CN) 201110455941.0

(51) Int. Cl. H01M 10/056; H01M 10/0569; H01M 2/16; H01M 4/66; H01M 4/50; H01M 4/583; H01M 2/02; H01M 10/0565

(52) U.S. Cl. 429/163; 429/122; 429/188; 429/202; 429/199; 429/206; 429/204; 429/200; 429/203; 429/325; 429/326; 429/329; 429/337; 429/339; 429/340; 429/338; 429/331; 429/341; 429/213; 429/224; 429/231.5; 429/231.8

(57) ABSTRACT

An energy storage device including an active electrolyte, a first electrode and a second electrode is provided. The active electrolyte contains protons and ion pairs with a redox ability. The first electrode and the second electrode coexist in the active electrolyte and are separated from each other. The first electrode and the second electrode respectively include an active material producing a redox-reaction with the active electrolyte or an active material producing ion adsorption/desorption with the active electrolyte. The active electrolyte receives electrons from the first electrode and/or the second electrode so as to perform a redox-reaction for charge storage.

### CROSS-REFERENCE TO RELATED APPLICATION

This application claims the priority benefit of China application serial no. 201110455941.0, filed on Dec. 27, 2011. The entirety of the above-mentioned patent application is hereby incorporated by reference herein and made a part of this specification.

### BACKGROUND

1. Technical Field

The disclosure relates to an energy storage device and more particularly relates to an energy storage device that includes an active electrolyte.

2. Description of Related Art

In the 21^{st} century, our demand for electric energy grows increasingly, and as a consequence the demand for electrochemical energy storage devices is increasing as well. Batteries and electrochemical capacitors are the main stream of energy storage devices. Supercapacitors (ultracapacitors) have higher storage capacity, quicker recharging-discharging characteristics than general capacitors, and can provide instant high power output. Thus, they have drawn a lot of attention from researchers in the relevant fields. At present, supercapacitors can be roughly categorized into three types: (1) electric double layer capacitor (EDLC); (2) redox-capacitor (pseudo-capacitor); and (3) hybrid capacitor, which is a combination of the foregoing two types.

The EDLC mainly uses a porous substance as an active material thereof and utilizes the characteristic of high surface area to store electric energy. The electric capacity of EDLC is interrelated to the pores size and the volume of ions in the electrolyte. Because large ions cannot enter small-sized pores, those larger than middle pores (2-50 nm) are mainly for electricity storage. However, the electric capacity of EDLC is limited to the ion adsorption/desorption between the electrolyte and electrode surface. Therefore, the electric capacity cannot satisfy the current demand.

The redox-capacitor utilizes a faraday charge transfer reaction, instead of the electrostatic attraction of EDLC, to increase the electric capacity by dozens of times. Therefore, the affinity that the active material has to charged ions has a large influence on the electric capacity of the redox-capacitor. However, the faradic reaction is sometimes irreversible, and as a result, the active material adsorbed with electric charges cannot be discharged effectively, which reduces the cycle life. In addition, the electric capacity is limited by the doping/dedoping degree of the active substance.

Hence, how to further improve the electric capacity of supercapacitors has become an important issue nowadays.

### SUMMARY

The disclosure provides an energy storage device, which includes an active electrolyte.

The disclosure provides an energy storage device, which includes an active electrolyte, a first electrode, and a second electrode. The active electrolyte includes protons and ion pairs having a redox ability. The first electrode and the second electrode coexist in the active electrolyte and are electrically separated from each other. The first electrode and the second electrode respectively include an active material that produces a redox-reaction or an active material that produces ion adsorption/desorption with the active electrolyte. The active electrolyte receives electrons from the first electrode and/or the second electrode, so as to perform a redox-reaction for charge storage.

According to an embodiment of the disclosure, the active electrolyte of the energy storage device, for example, contains multivalent ion pairs with a redox ability, a supporting electrolyte, and a solvent.

According to an embodiment of the disclosure, ions of the multivalent ion pairs include chromium ions, sulfur ions, iron ions, bromine ions, tin ions, antimony ions, titanium ions, copper ions, cerium ions, magnesium ions, vanadium ions, or a combination of the above, for example.

According to an embodiment of the disclosure, the supporting electrolyte includes sulfuric acid, hydrochloric acid, nitric acid, phosphoric acid, LiOH, NaOH, KOH, LiClO₄, LiNO₃, LiBF₄, LiPF₆, (C₂H₅)₄N(PF₆), (C₂H₅)₄N(BF₄), (C₂H₅)₃(CH₃)N(PF₆), (C₂H₅)₃(CH₃)N(BF₄), or a combination of the above, for example.

According to an embodiment of the disclosure, the solvent includes water, alcohol, ketone, ethylene carbonate, propylene carbonate, dimethyl carbonate, diethyl carbonate, ethyl methyl carbonate, gamma-butyrolactone, sulfolane, acetonitrile, tetrahydrofuran, dimethyl sulfoxide, dimethylformamide, or a combination of the above, for example.

According to an embodiment of the disclosure, the electrode that produces a redox-reaction with the active electrolyte includes a conductive substrate and a conductive polymer or a proton-inserted metallic oxide, wherein the conductive polymer or the proton-inserted metallic oxide is disposed on the conductive substrate.

According to an embodiment of the disclosure, the conductive polymer includes polyaniline, polypyrrole, polythiophene, polyacetylene, poly(phenylene vinylene), a derivative thereof, a polymer thereof, or a copolymer thereof, for example.

According to an embodiment of the disclosure, the proton-inserted metallic oxide is, for example, tungsten oxide, molybdenum oxide, ruthenium oxide, manganese oxide, or a combination thereof.

According to an embodiment of the disclosure, the electrode that produces ion adsorption/desorption with the active electrolyte includes a conductive substrate and a carbon material having a surface area larger than 50 m²/g, and the carbon material is disposed on the conductive substrate.

According to an embodiment of the disclosure, the carbon material is, for example, activated carbon, graphite carbon, carbon cloth, carbon felt, or a combination thereof.

According to an embodiment of the disclosure, a material of the conductive substrate is platinum, gold, silver, titanium, an alloy thereof, or a combination thereof, for example.

According to an embodiment of the disclosure, the energy storage device further includes an isolating film that is disposed between the first electrode and the second electrode.

According to an embodiment of the disclosure, the isolating film has ion conductibility, for example.

According to an embodiment of the disclosure, the isolating film is a polymer film containing sulfonic acid, phosphonic acid or carboxylic acid functional groups, or a composite film thereof, for example.

According to an embodiment of the disclosure, the isolating film has no ion conductibility, for example.

According to an embodiment of the disclosure, a material of the isolating film is a porous synthetic fiber film, a natural fiber film, a composite thereof, or a blend film thereof, for example.

According to an embodiment of the disclosure, the first electrode, the second electrode, and the active electrolyte are disposed in a container, for example.

Based on the above, because the active electrolyte, the first electrode, and the second electrode in the energy storage device of the disclosure all have capacity for charge storage, the electric capacity of the energy storage device is effectively improved.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view according to an exemplary embodiment of the disclosure.

FIG. 2 is a schematic cross-sectional view according to another exemplary embodiment of the disclosure.

FIG. 3 is a schematic cross-sectional view according to yet another exemplary embodiment of the disclosure.

### DETAILED DESCRIPTION OF DISCLOSED EMBODIMENTS

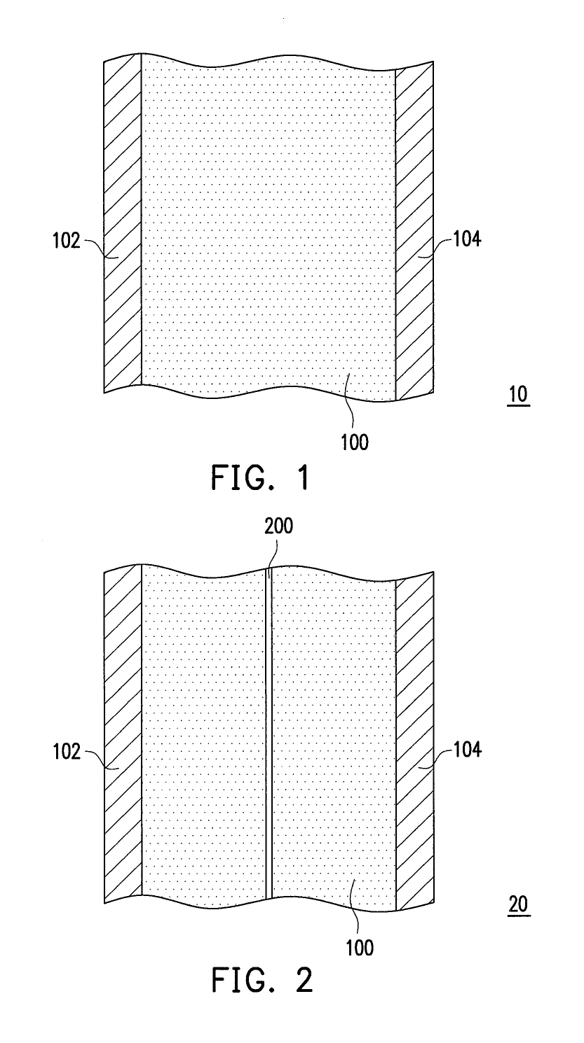

FIG. 1 is a schematic cross-sectional view according to an exemplary embodiment of the disclosure. Referring to FIG. 1, an energy storage device 10 of this embodiment includes an active electrolyte 100, a first electrode 102, and a second electrode 104. In this embodiment, the first electrode 102 and the second electrode 104 are not limited to certain polarity. That is, the first electrode 102 can be an anode and the second electrode 104 can be a cathode; or alternatively the first electrode 102 can be a cathode and the second electrode 104 can be an anode. The first electrode 102 and the second electrode 104 are disposed in the active electrolyte 100 and are electrically separated from each other. The active electrolyte 100, the first electrode 102, and the second electrode 104 are further described in the following paragraphs.

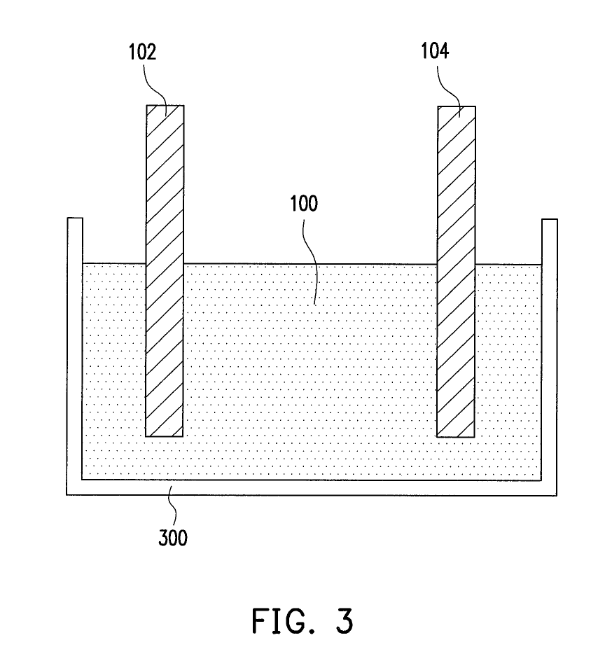

The active electrolyte 100 includes protons and ion pairs having a redox ability. Specifically, the active electrolyte 100, for example, contains multivalent ion pairs with a redox ability, a supporting electrolyte, and a solvent, wherein the multivalent ion pairs provides the ion pairs having the redox ability and the supporting electrolyte provides the protons. The ions of the multivalent ion pairs are chromium ions, sulfur ions, iron ions, bromine ions, tin ions, antimony ions, titanium ions, copper ions, cerium ions, magnesium ions, vanadium ions, or a combination of the above. The supporting electrolyte includes sulfuric acid, hydrochloric acid, nitric acid, phosphoric acid, LiOH, NaOH, KOH, LiClO₄, LiNO₃, LiBF₄, LiPF₆, (C₂H₅)₄N(PF₆), (C₂H₅)₄N(BF₄), (C₂H₅)₃(CH₃)N(PF₆), (C₂H₅)₃(CH₃)N(BF₄), or a combination of the above. The solvent includes water, alcohol, ketone, ethylene carbonate, propylene carbonate, dimethyl carbonate, diethyl carbonate, ethyl methyl carbonate, gamma-butyrolactone, sulfolane, acetonitrile, tetrahydrofuran, dimethyl sulfoxide, dimethylformamide, or a combination of the above. A concentration of the multivalent ion pairs is for example in a range of 0.5 M˜3.5 M, and preferably between 1 M and 2 M. A concentration of the supporting electrolyte is for example in a range of 0.5 M˜3.5 M, and preferably between 1 M and 2 M. It should be noted that, in this embodiment, the active electrolyte 100 is static, not circulated. For example, in an exemplary embodiment as shown in FIG. 3, the first electrode 102, the second electrode 104, and the active electrolyte 100 are disposed in a container 300. The active electrolyte 100 is static in the container 300 and does not flow outside the container 300.

The first electrode 102 is an electrode that produces a redox-reaction with the active electrolyte 100 or an electrode that produces ion adsorption/desorption with the active electrolyte 100. Moreover, the second electrode 104 is the electrode that produces a redox-reaction with the active electrolyte 100 or the electrode that produces ion adsorption/desorption with the active electrolyte 100. The electrode producing a redox-reaction with the active electrolyte 100 is generally called a redox electrode, and the electrode producing ion adsorption/desorption with the active electrolyte 100 is generally called an electric double layer electrode. To be more specific, according to the types of the first electrode 102 and the second electrode 104, the energy storage device 10 of this embodiment is categorized into four types. In the first type, the first electrode 102 and the second electrode 104 are both redox electrodes. In the second type, the first electrode 102 is the redox electrode and the second electrode 104 is the electric double layer electrode. In the third type, the first electrode 102 is the electric double layer electrode and the second electrode 104 is the redox electrode. In the fourth type, the first electrode 102 and the second electrode 104 are both electric double layer electrodes.

In this embodiment, the electrode that produces a redox-reaction with the active electrolyte 100 includes a conductive substrate and a conductive polymer or a proton-inserted metallic oxide, wherein the conductive polymer or the proton-inserted metallic oxide is disposed on the conductive substrate. The conductive polymer is polyaniline, polypyrrole, polythiophene, polyacetylene, poly(phenylene vinylene), a derivative thereof, a polymer thereof, or a copolymer thereof, for example. The proton-inserted metallic oxide is tungsten oxide, molybdenum oxide, ruthenium oxide, manganese oxide, or a combination of the above, for example. Furthermore, in this embodiment, the electrode that produces ion adsorption/desorption with the active electrolyte 100 includes a conductive substrate and a carbon material, which is disposed on the conductive substrate and has a surface area larger than 50 m²/g. A material of the conductive substrate is platinum, gold, silver, titanium, an alloy thereof, or a combination thereof, for example. The conductive substrate is used for collecting charges and may have a plate shape, a mesh shape, or other suitable shapes. The carbon material is, for example, activated carbon, graphite carbon, carbon cloth, carbon felt, or a combination thereof. The carbon material having large surface area has higher charge storage capacity.

In this embodiment, the electrode (redox electrode) that produces a redox-reaction with the active electrolyte 100 stores charges by performing a redox-reaction with the active electrolyte 100 and conducts electrons to the multivalent ion pairs in the active electrolyte 100. Moreover, the electrode (electric double layer electrode) that produces ion adsorption/desorption with the active electrolyte 100 stores charges by performing ion adsorption/desorption in the active electrolyte 100 and conducts electrons to the multivalent ion pairs in the active electrolyte 100. In addition, because the active electrolyte 100 contains protons and ion pairs having the redox ability, when the active electrolyte 100 receives electrons from the first electrode 102 and the second electrode 104, charges are stored by the redox-reactions of the multivalent ion pairs. In other words, in this embodiment, the active electrolyte 100, the first electrode 102, and the second electrode 104 all have capacity for storing charges. Therefore, compared with a general energy storage device (wherein only the electrodes have charge storage capacity), the energy storage device 10 of this embodiment has higher electric capacity.

It is noted that, when the proton-inserted metallic oxide is used as the material of the electrode, the protons generated by the redox-reactions of the multivalent ion pairs are inserted to maintain charge balance in the energy storage device 10. Because the redox-reactions of the multivalent ion pairs have higher reversibility, better capacitance maintenance is obtained. In addition, in this embodiment, there is a larger difference between oxidation and reduction potentials of the multivalent ion pairs, and therefore, the redox-reaction can be completely performed.

In order to effectively isolate the first electrode 102 from the second electrode 104 to avoid short circuit caused by contact, an isolating film is further disposed between the first electrode 102 and the second electrode 104. Details are described below.

FIG. 2 is a schematic cross-sectional view according to another exemplary embodiment of the disclosure. With reference to FIG. 2, a difference between the energy storage device 10 and an energy storage device 20 of this embodiment lies in that: in the energy storage device 20, an isolating film 200 is disposed between the first electrode 102 and the second electrode 104 to electrically isolate the first electrode 102 from the second electrode 104 effectively.

In an exemplary embodiment, the isolating film 200 has ion conductibility to allow the protons (i.e. H⁺) in the active electrolyte 100 to pass through the isolating film 200. The isolating film 200 is a polymer film containing sulfonic acid, phosphonic acid or carboxylic acid functional groups, or a composite film thereof, such as perfluorinated sulfonated polymer film, partially fluorinated sulfonated polymer film, sulfonated hydrocarbon polymer film, perfluorinated phosphated polymer film, partially fluorinated phosphated polymer film, phosphated hydrocarbon polymer film, perfluorinated carboxylated polymer film, partially fluorinated carboxylated polymer film, carboxylated hydrocarbon polymer film, etc. Moreover, in another exemplary embodiment, the isolating film 200 does not have ion conductibility and is used for electrically isolating the first electrode 102 and the second electrode 104 only. In this embodiment, a material of the isolating film 200 is, for example, a porous synthetic fiber film or a natural fiber film, such as a porous polyethylene film, a porous polypropylene film, a porous polyacrylonitrile film, a porous polyethylene terephthalate film, a plant fiber film, a combination of the above, or a blend film of the above.

Similar to FIG. 3, in an exemplary embodiment, the first electrode 102, the second electrode 104, the active electrolyte 100, and the isolating film 200 may be disposed in a container. The active electrolyte 100 is static in the container and does not flow outside the container.

The energy storage device of the disclosure is further described with reference to the embodiments and comparison examples in the following paragraphs.

In the following embodiments and comparison examples, the energy storage device is formed by two electrodes and an ion conductive film, disposed in an active electrolyte. In each embodiment, the active electrolyte is prepared by adding 2M VOSO₄ .xH₂O (Aldrich, 97%)(as the multivalent ion pairs) into 2M H₂SO₄ (Aldrich, 97%)(as the supporting electrolyte) and water (as the solvent).

### Fabrication of Electrode Having Conductive Polymer:

Polyaniline (Aldrich), poly-3-methylthiophene or polypyrrole (Aldrich), conductive carbon (KS6(Cabot), Super P(TIMCAL Graphite & Carbon)), and an adhesive agent (EPDM) are blended to form a film by a weight ratio of 75 : 15 : 10. Next, the film is adhered to a titanium foil (Alfa Aesar) by an adhesive agent (Acheson EB012), which is then compressed and cut into an electrode plate with a diameter of 12 mm.

### Fabrication of Electrode Having Proton-Inserted Metallic Oxide

Tungsten oxide or molybdenum oxide is mixed with the aforesaid conductive carbon and adhesive agent (weight ratio 75:15:10) to form a film. The same process is performed to cut it into an electrode plate with a diameter of 12 mm. Fabrication of Electrode Having Carbon Material with Large Surface Area:

Activated carbon (with surface area of 2600 m²/g) is mixed with the aforesaid conductive carbon and adhesive agent (weight ratio 75:15:10) to form a film. Then, the same process is performed to cut it into an electrode plate with a diameter of 12 mm.

Ion conductive film: Nafion® NR-212(DuPont), sPEEK(sulfonated polyether ether ketone, BASF)

In the embodiments and comparison examples, a measured discharge capacity per unit weight (C) is calculated based on discharge current (I), time (t), working voltage (V), and weights of two electrodes (W). The equation is provided below:

$$C = \frac{I \times t}{V \times W}$$

In addition, the working voltage range of an organic electrolyte is 0 V˜2.5 V, and that of the aqueous electrolyte is 0 V˜1 V. When constant current charged/discharged is 1 mA, the experiment results are specified in Table I below.

TABLE I

| | Embodiment 1 | Embodiment 2 | Embodiment 3 | Embodiment 4 | Embodiment 5 | Embodiment 6 |
|---|---|---|---|---|---|---|
| Anode | Pani | PMeT | Pani | PMeT | Pani | PMeT |
| Isolating | NR-212 | NR-212 | NR-212 | NR-212 | NR-212 | NR-212 |
| Film | | | | | | |
| Cathode | Ppy | Ppy | MoOₓ (x = 2~3) | MoOₓ (x = 2~3) | AC | AC |
| Electrolyte | 2M VOSO₄ + | 2M VOSO₄ + | 2M VOSO₄ + | 2M VOSO₄ + | 2M VOSO₄ + | 2M VOSO₄ + |
| | 2M H₂SO₄ | 2M H₂SO₄ | 2M H₂SO₄ | 2M H₂SO₄ | 2M H₂SO₄ | 2M H₂SO₄ |
| Discharge | 34.029 | 38.136 | 65.202 | 40.275 | 27.093 | 35.985 |
| Capacitance | | | | | | |
| (F/g) | | | | | | |

| | Embodiment 7 | Embodiment 8 | Embodiment 9 | Embodiment 10 | Embodiment 11 |
|---|---|---|---|---|---|
| Anode | AC | AC | AC | AC | AC |
| Isolating | NR-212 | NR-212 | NR-212 | sPEEK | Non-woven |
| Film | | | | | fabric |
| Cathode | WO₃ | MoOₓ (x = 2~3) | AC | AC | AC |
| Electrolyte | 2M VOSO₄ + | 2M VOSO₄ + | 2M VOSO₄ + | 2M VOSO₄ + | 2M VOSO₄ + |
| | 2M H₂SO₄ | 2M H₂SO₄ | 2M H₂SO₄ | 2M H₂SO₄ | 2M H₂SO₄ |
| Discharge | 25.048 | 71.410 | 30.299 | 38.287 | 28.675 |
| Capacitance | | | | | |
| (F/g) | | | | | |

| | Comparison | Comparison |
|---|---|---|
| | Example 1 | Example 2 |
| Anode | AC | AC |
| Isolating | NR-212 | Cellulose |
| Film | | |
| Cathode | AC | AC |
| Electrolyte | 2M H₂SO₄ | 1M TEAPF₆ |
| Discharge | 16.002 | 16.632 |
| Capacity per | | |
| Gram (F/g) | | |

In Table I, Pani represents an electrode formed by polyaniline; Ppy represents an electrode formed by polypyrrole; PMeT represents an electrode formed by poly-3-methylthiophene; AC represents an electrode formed by activated carbon; and TEAPF₆ represents a propylene carbonate electrolyte of hexafluorophosphate tetraethylammonium (organic electrolyte). In Embodiments 1-4, the anode is a redox electrode and the cathode is also a redox electrode. In Embodiments 5 and 6, the anode is a redox electrode and the cathode is an electric double layer electrode. In Embodiments 7 and 8, the anode is an electric double layer electrode and the cathode is a redox electrode. In Embodiments 9-11, the anode is an electric double layer electrode and the cathode is also an electric double layer electrode. In Comparison Examples 1 and 2, the anode is an electric double layer electrode and the cathode is also an electric double layer electrode. Moreover, in Embodiments 1-11, the electrolyte is an active electrolyte; but in Comparison Examples 1 and 2, the electrolyte is a non-active electrolyte.

Table I clearly shows that a discharge capacitance of Embodiments 1-11, which include the active electrolyte, is higher than a discharge capacity per gram of Comparison Examples 1-2. It is known from the above that the multivalent ion pairs introduce the ability of charge storage in the electrolyte. That is, because the active electrolyte, the anode, and the cathode in the energy storage device of the disclosure all have capacity for storing charges, the energy storage device has higher electric capacity.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An energy storage device, comprising:
an active electrolyte, comprising protons and ion pairs having a redox ability; and
a first electrode and a second electrode, wherein the first electrode and the second electrode coexist in the active electrolyte and are electrically separated from each other, the first electrode and the second electrode respectively comprise an active material that produces a redox-reaction with the active electrolyte or an active material that produces ion adsorption/desorption with the active electrolyte, and the active electrolyte receives electrons from the first electrode and/or the second electrode to perform a redox-reaction for charge storage.

2. The energy storage device according to claim 1, wherein the active electrolyte comprises multivalent ion pairs having the redox ability, a supporting electrolyte, and a solvent.

3. The energy storage device according to claim 2, wherein ions of the multivalent ion pairs comprise chromium ions, sulfur ions, iron ions, bromine ions, tin ions, antimony ions, titanium ions, copper ions, cerium ions, magnesium ions, vanadium ions, or a combination of the above.

4. The energy storage device according to claim 2, wherein the supporting electrolyte comprises sulfuric acid, hydrochloric acid, nitric acid, phosphoric acid, LiOH, NaOH, KOH, LiClO₄, LiNO₃, LiBF₄, LiPF₆, (C₂H₅)₄NPF₆), (C₂H₅)₄N(BF₄), (C₂H₅)₃(CH₃)N(PF₆), (C₂H₅)₃(CH₃)N(BF₄), or a combination of the above.

5. The energy storage device according to claim 2, wherein the solvent comprises water, alcohol, ketone, ethylene carbonate, propylene carbonate, dimethyl carbonate, diethyl carbonate, ethyl methyl carbonate, gamma-butyrolactone, sulfolane, acetonitrile, tetrahydrofuran, dimethyl sulfoxide, dimethylformamide, or a combination of the above.

6. The energy storage device according to claim 1, wherein the active material that produces a redox-reaction with the active electrolyte comprises a conductive polymer or a proton-inserted metallic oxide, and the conductive polymer or the proton-inserted metallic oxide is disposed on a conductive substrate.

7. The energy storage device according to claim 6, wherein the conductive polymer comprises polyaniline, polypyrrole, polythiophene, polyacetylene, poly(phenylene vinylene), a derivative thereof, a polymer thereof, or a copolymer thereof.

8. The energy storage device according to claim 6, wherein the proton-inserted metallic oxide comprises tungsten oxide, molybdenum oxide, ruthenium oxide, manganese oxide, or a combination thereof.

9. The energy storage device according to claim 6, wherein a material of the conductive substrate comprises platinum, gold, silver, titanium, an alloy thereof, or a combination thereof.

10. The energy storage device according to claim 1, wherein the active material that produces ion adsorption/desorption with the active electrolyte comprises a carbon material having a surface area larger than 50 m²/g, and the carbon material is disposed on a conductive substrate.

11. The energy storage device according to claim 10, wherein the carbon material comprises activated carbon, graphite carbon, carbon cloth, carbon felt, or a combination thereof.

12. The energy storage device according to claim 10, wherein a material of the conductive substrate comprises platinum, gold, silver, titanium, an alloy thereof, or a combination thereof.

13. The energy storage device according to claim 1, further comprising an isolating film disposed between the first electrode and the second electrode.

14. The energy storage device according to claim 13, wherein the isolating film has ion conductibility.

15. The energy storage device according to claim 14, wherein the isolating film comprises a polymer film containing sulfonic acid, phosphonic acid or carboxylic acid functional groups, or a composite film thereof.

16. The energy storage device according to claim 13, wherein the isolating film has no ion conductibility.

17. The energy storage device according to claim 16, wherein a material of the isolating film comprises a porous synthetic fiber film, a natural fiber film, a composite thereof, or a blend film thereof.

18. The energy storage device according to claim 1, wherein the first electrode, the second electrode, and the active electrolyte are disposed in a container.
